(19) United States
(12) Patent Application Publication
(10) Pub. No.: US 2015/0190878 A1
(43) Pub. Date: Jul. 9, 2015

(54) Apparatus and Method for use of Rotating Arc Process Welding

(71) Applicants: Richard A Roen, Centennial, TX (US); Eric M. Christofferson, Spring, TX (US); Michael S. Wall, JR., Humble, TX (US)

(72) Inventors: Richard A Roen, Centennial, TX (US); Eric M. Christofferson, Spring, TX (US); Michael S. Wall, JR., Humble, TX (US)

(73) Assignee: Weld Revolution, LLC, Tomball, TX (US)

(21) Appl. No.: 14/415,982

(22) PCT Filed: Jul. 9, 2013
(86) PCT No.: PCT/US2013/049700

§ 371 Date: Jan. 20, 2015

(51) Int. Cl. B23K 9/133

(52) U.S. Cl. CPC B23K 9/133

(57) ABSTRACT

An arc welding apparatus that imparts a rotational movement to the tip of the consumable electrode to cause molten metal to be thrown by centrifugal force against the sidewall of the slot between metal work pieces being welded. The welding apparatus being configurable to control speed, direction, and/or placement of the electrical arc in relation to the slot. The welding apparatus being configurable to pair with other similar devices and to be cooperatively operated in close proximity and\or on a single weld puddle to accomplish larger and/or complex welds in rapid, repeatable succession.

### CROSS-REFERENCE TO RELATED APPLICATIONS

This application claims priority to PCT Application #PCT/US13/49700 titled “Apparatus and Method for Use of Rotating Arc Process Welding” filed in the US receiving office on 9 Jul. 2013, which is incorporated herein by reference.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO SEQUENCE LISTING, A TABLE, OR A COMPUTER PROGRAM LISTING APPENDIX SUBMITTED ON COMPACT DISC

Not applicable.

### BACKGROUND OF THE INVENTION

The present invention relates to arc welding which uses a continuous feed of a consumable wire electrode and more particularly to such continuous arc welding where lateral movement is imparted to the arcing end of the electrode in a controlled and continually adjustable manner.

Continuous arc welding is affected by variables such as the use of selected gases and blends of gases; selected fluxes; metals or alloy of metals; joint or slot preparation; wire size and feed rate; movement rate of the torch along the slot, and the amount of current applied. Also, there must be a determination as to whether a single pass or several passes are best for the job. These and other considerations make continuous arc welding more of an art than a science as explained in our previous patents, U.S. Pat. No. 4,177,373, dated 4 Dec. 1979, entitled “Oscillation Arc Welding,” and U.S. Pat. No. 4,401,878, dated 30 Aug. 1983, entitled “Consumable Arc Welding Torch,” both of which are hereby incorporated by referenced in their entirety.

Set-up problems are often encountered during welding. Even minor variations in the width of the slot between metals to be joined, thickness of materials to be joined, and electrical resistances caused by material imperfections, coatings, dirt, or grease, all affect the progress of a weld operation, and must be continuously adjusted to achieve a more precise weld. A number of refinements have been developed in welding equipment to overcome the problems encountered, especially in automatic equipment. There is, nevertheless, room for further improvement and several improvements are disclosed below.

### BRIEF DESCRIPTION OF THE DRAWINGS

With the foregoing and other objects in view, all of which more fully hereinafter appear, my invention comprises certain combinations, constructions and arrangements of parts and elements, and operations, sequences and steps, all as hereinafter described, defined in the appended claims and illustrated in preferred embodiment in the accompanying drawings in which:

FIG. 1 is a diagrammatic elevational view of a continuous arc welding apparatus arranged for manual use incorporating therein the torch improvements in accordance with an exemplary embodiment of the invention.

FIG. 2 is a diagrammatic elevational view of an alternative embodiment of a continuous arc welding apparatus arranged for manual use incorporating therein the torch improvements in accordance with an exemplary embodiment of the invention.

FIG. 3 is a sectional elevational view of the torch body on an enlarged scale.

FIG. 4 is a diagrammatic elevational view of a mechanized continuous arc welding apparatus incorporating the improved torch in accordance with an exemplary embodiment of the invention.

FIG. 5 is a diagrammatic elevational view of a mechanized continuous arc welding apparatus incorporating a plurality of improved torches in accordance with an exemplary embodiment of the invention.

FIG. 5A is another diagrammatic elevational view of a mechanized continuous arc welding apparatus incorporating a plurality of improved torches, and a rotational offset capability in accordance with an exemplary embodiment of the invention.

FIGS. 6A, 6B, and 6C are diagrams of exemplary welding paths and characteristics thereof for multi torch systems as illustrated in FIG. 5.

FIGS. 7 and 8 are elevational views of certain operative components within the torch and showing in a somewhat exaggerated manner the movement of a wand carrying the electrode wire and the effect of adjustments and alternatives thereon in accordance with an exemplary embodiment of the invention.

FIGS. 9A, 9B, and 10 show sectional elevations of certain operative components within the torch in accordance with an exemplary embodiment of the invention.

FIGS. 11 and 13 show elevational views of certain operative components within the torch in accordance with an exemplary embodiment of the invention.

FIGS. 12, 12′ and 14 show sections of metal plates being joined together by welds according to the present invention.

FIG. 15 illustrates an elevational view of an alternative embodiment of a torch in accordance with an exemplary embodiment of the invention.

FIG. 15A shows a transverse sectional view as taken from the indicated line A-A at FIG. 15.

FIG. 16 shows a cross sectional elevation of the alternative embodiment of the torch illustrated in FIG. 15.

FIG. 16A shows an enlarged view of the base end of the torch body illustrated in FIG. 16.

FIG. 16B shows a transverse sectional view as taken from the indicated line B-B at FIG. 16.

FIG. 17 diagrams a method of use for a mechanized continuous arc welding apparatus incorporating the improved torch as illustrated in FIG. 4.

FIG. 17A diagrams a method of use for a mechanized continuous arc welding apparatus incorporating a plurality of improved torches as illustrated in FIG. 5.

FIG. 18 is a diagrammatic elevational view of a continuous arc welding torch in accordance with an exemplary embodiment of the invention.

FIG. 18A shows a transverse sectional view as taken from the indicated line 18A-18A at FIG. 18.

### DETAILED DESCRIPTION OF THE INVENTION AND THE PREFERRED EMBODIMENTS

The present invention extends the state of the art beyond that disclosed in my previous patents. Improvements involve control of variables in the weld process, particularly continuous adjustments made in response to continuous monitoring of the weld and the impact such adjustments cause.

In prior designs, a variable speed electrical motor was coupled with a variable speed control which varied the speed of the motor by varying the voltage until the approximate frequency of rotation was obtained. Improvements discussed herein comprise utilization of stepping motors (128) with accompanying electronic control (MC) for precise positioning of the motor's shaft, rotation speed, and direction. Additional improvements comprise adjusting the length of the torch's elongated wand and tip to further adjust the physical characteristics of the electrode's path.

The improvements further comprise separation of gas, electrode, and power into separate feeds for more precise routing, control, and sharing among a plurality of torches in mechanized apparatuses. Further, improved control over the electrode path allows for a plurality of torches to operate in such close proximity such that a common weld puddle may be maintained between multiple torches.

As described in prior patents, drops of molten metal are impelled from the electrode(s) to the side walls of the slot to build up a puddle of molten metal in the slot. In my prior inventions, the movement of the electrode was a circular path with drops of molten metal being thrown by centrifugal force. This movement of the arc end of the electrode was called “rotation” although it is to be understood that the electrode wire does not rotate but, rather, revolves about an axis. In the improved invention, more precise control over the motor allows for complex paths which may not involve a complete circular path and/or may involve several other adjustments in direction or speed. For simplicity, unless specifically described, the motor movements, and the resulting electrode paths will continue to be referred to generically as rotation.

Controlling the length of the wand affects the distance between the tip and the weld slot. In mechanical apparatuses, additional torch positioning capabilities coupled with the wand length can precisely control the distance that the weld tip is maintained above the weld surface. The radius of the rotation when the electrode is within the weld slot and the angle of the torch can affect the resistance the motor may experience when changing position, or the current flow through the wire. Experienced welders can sense these changes by the brightness of the arc, the sound of the machinery, and/or other physical characteristics of the process.

In the improved design described herein, a controller may include current sensors, light sensors, microphones, vibration sensors, etc. which provide feedback to the controller which reactively adjust the position and physical characteristics of the torch accordingly to achieve better welds. Further, the speed at which the controller can accomplish such adjustments results in more consistent welds.

The refined control that stepping motors impart on the process allows the rotation to be precisely adjusted. In the preferred embodiment a servo motor is utilized for wire rotation. One skilled in the arts would appreciate that stepper motors could also be utilized. Stepping motors allow precise positioning and movements in either direction without relation to the previous movements. This is a dramatic improvement over the previous variable speed motors which could not be positioned or held in a unique location for precise timing increments.

As an example of the flexibility achievable with stepping motors over variable speed motors, rotation at varying speeds can determine the radius of a circular wire path due to centrifugal forces. However, varying the speed of rotation consistently throughout the rotation by varying the step patterns can change the shape of the wire path. If the speed varies four times per revolution, increasing speed at times 1 and 3 while reducing speed at times 2 and 4, wherein times 1-4 for evenly spaced and concurrent along the revolution path, then the resulting changes in centrifugal force would result in an elliptical path rather than a circular one. Carried to extremes, then elliptical path could be elongated in a single plan and compressed in the perpendicular plane to substantially become a linear motion.

Alternatively, continuously reversing the direction of the rotation without making full rotations can reduce the path to a single back and forth movement. By adjusting the speed of the stepping, and the number of steps in each direction, the width of the path can be controlled, and an arch shape can be imparted.

Since stepper motors allow precise positioning of a motor within a revolutionary path, precise control allows a plurality of motors to be operated in close proximity wherein their paths may overlap one another. This was previously impossible with variable speed motors where even minute variations in the internal resistance or other physical characteristics of seemly identical motors would result in speed variances and result in interferences.

Precise speed control along precise locations of the rotational path allows increased deposition of metal at one sidewall. This is an exceptional improvement for welds in horizontal slots between vertical plates. By providing an excess of metal at the upper plate, a more uniform weld is possible. Another improvement resides in welding plates of differing thickness with the increased deposition of metal being at the thicker plate.

A desirable result attainable with this welding process resides in the discovery that a welding operation could proceed faster than possible with a comparable conventional apparatus apparently because complex movement of the electrode stabilizes the arc so that its action is continuous. The electric current, the wire feed rate and the torch movement rate may be increased once the welding operation is commenced. Further, the coordination of multiple welding torches operating together on a mechanized apparatus reduces multi-pass operations to a single pass.

Multiple torch operations can benefit from the more precise control of each individual torch because interference between the torches is eliminated, and both can be adjusted for optimum performance at a common rate of progression along the weld seam even when each torch is performing a different task, i.e. a primary torch is performing a root weld, and one or more secondary torches are performing filler passes.

With simple modifications, the process described herein could be adapted for utilization in Gas Tungsten Arc welding. The consumable, referred to elsewhere in this description as the electrode wire (W), would be routed outside of the electrode to meet the weld and feed from outside of the wand, rather than through a central axial passageway. One skilled in the art would appreciate that polarity would need to be reversed, and some other minor modifications made to account for the differences in process. The consumable would be fed into the arc between the rotating tungsten wand and the seam as is standard in the Gas Tungsten Arc welding process.

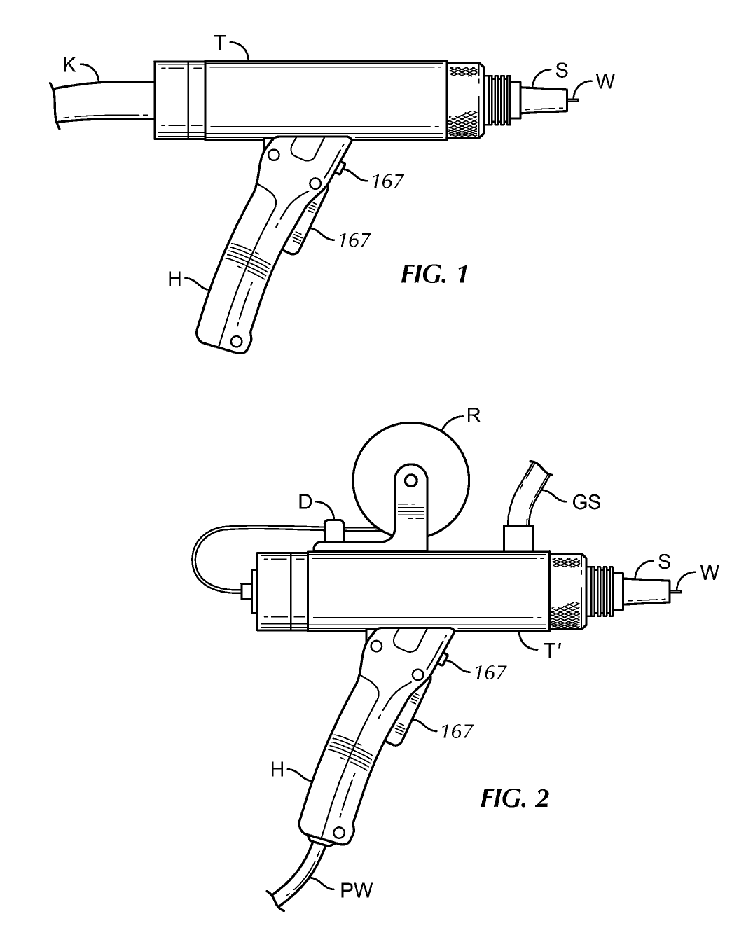

Referring more particularly to the drawings, the improved torch (T or T′) is used in a conventional manner and with conventional equipment. FIG. 1 shows the torch (T′) adapted for manual welding with a flexible, multipurpose, tubular carrier conduit (K) which carries electrode wire (W), Shielding Gas, and Power Supply in a single conduit. FIG. 2 shows the torch (T′) with individual inputs for Shielding Gas (GS), Power Supply (PW), and electrode wire (W) which is fed by a wire drive (D) from a supply reel (R). Both units (T and T′) have a handle (H) with integrated motor controls (167). The handle (H) is preferably encased in an insulator to avoid accidental shorting when in use. The electric current is supplied by a generator (G) not shown. The electrode wire (W) on a supply reel (R) is fed into the torch (T and T′) by a wire drive (D). Shielding gas, of any suitable type, will flow from a source (not shown) through a supply line (GS or K) through the torch (T and T′) to the gas shield (S) which surrounds the electrode wire (W) where it exits the torch.

Various controls are associated with this welding apparatus to regulate the electrical current, the rate of wire movement through the torch, the flow of shielding gas and the rate of movement of the carriage (C not shown) along the track (N not shown). Such controls are conventional and are not further described when used conventionally in the present invention. It is to be noted however, that some improvements described herein comprise non-conventional use of the conventional controls including control by a control which may be a programmable controller or computing device as will hereinafter appear.

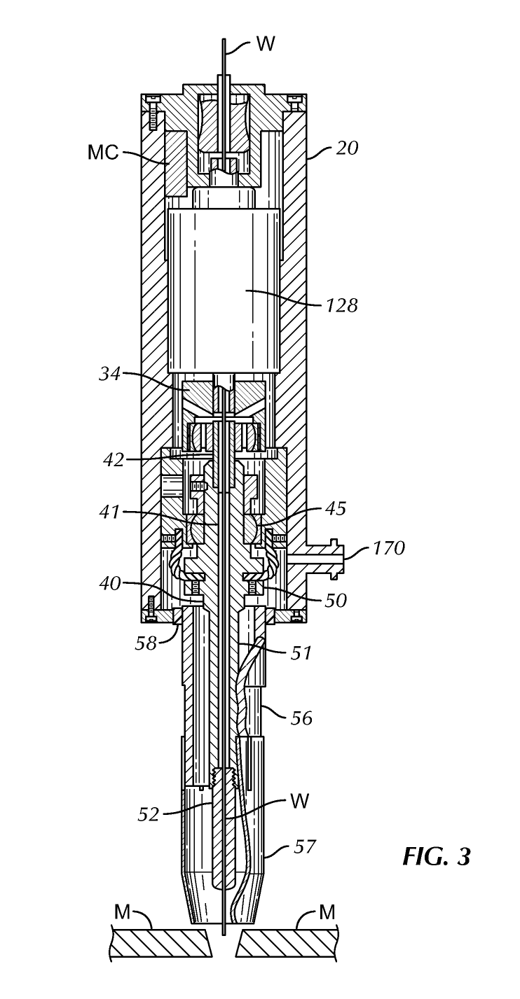

FIG. 3 is a sectional elevational view of the torch body on an enlarged scale. The improved torch (T or T′ not designated) includes a cylindrical, tubular body (20) wherein the several components which guide and rotate the electrode wire and form the gas passageway are located. The head of the torch, illustrated at the top of the diagram includes a central passageway through which the electrode wire (W) passes.

A cylindrical, stepping motor 128 is tightly mounted in the body 20 along with a controller (MC) which may include one or more circuits through which passes an Insulating Sleeve (IS) to protect the controller (MC) from electrical voltage/current carried by the electrode wire (W). The wire (W) passes through an axially centered hole in the stepping motor (128) to the rotor head (34) which may contain an O-ring to prevent gas from escaping through the head of the torch. One skilled in the art would appreciate that other options are available to prevent the gas from the gas supply connector port (170) from reaching the head of the torch, and that it may be desirable to protect the stepping motor (128) and/or the motor controller (MC) depending on the types of shielding gas and their properties.

The circular movement at the arc end of the electrode wire (W), also called “rotation,” is generated by a wand (40) having an axial passageway (41) through which the electrode wire (W) passes. This wand (40) is mounted in the lower portion of the body (20), below the rotor head (34) and its upper end, a tubular tip (42) fits into the eccentric spherical bearing (35) of the rotor head. The spherical rocker bearing (45) is mounted in a tubular sleeve which is tightly fitted into a cylindrical bore in the body (20), below the motor (128).

A short portion of the wand (40) below the bearing (45) is enlarged to form a cylindrical head (50) to provide sockets to receive electrical connector wires as described previously. The wand (40) below the head (50) is reduced in diameter and forms an elongated extension (51). The lower end of the wand, which extends below the body (20), is threaded to connect with a wire guide contact tip (52). This contact tip is a short cylindrical member of a selected metal, such as copper, and has a passageway through it which is only a few thousandths of an inch larger than the diameter of the wire (W) so that electrical contact can be made with the electrode wire as it moves through the tip (52). It is to be noted that in this improved torch the only adjustment needed for a different sized electrode wire is to change this tip (52). Arcing as during a welding operation will occur at the end of the electrode wire (W) extended a short distance below this tip.

The tubular body (20) terminates a short distance below the cylindrical head (50) where it is closed by a circular end. A gas shield tube (56) extends from the end to enclose the lower wand extension (51) projecting below the body (20). The tube (56) carries a shielding cap (57), which extends downwardly to enclose the contact tip (52) and a portion of the electrode wire (W) projecting from the tip (52). This shielding cap (57) is slidable on the tube (56) for adjustments of position with respect to the length of the projected electrode wire (W) and the length of the tip (52).

It is to be noted that the gas shield tube (56) insulated from the body (20) and the end of the body (20) and the connection of the tube (56) to the end of the body (20) is by an insulator ring (58) about the tube (56), and in a centered hole in the end of the body (20). This prevents an electrical short if the shielding cap is accidentally grounded as by touching a plate member (M).

FIG. 4 is a diagrammatic elevational view of a mechanized continuous arc welding apparatus incorporating the improved torch in accordance with an exemplary embodiment of the invention. The carriage (C) is mounted upon a track (N) and moved along the track (N) by the plunger (P). Metal plates (M) which are to be welded together are positioned alongside the track (N) and below the torch (T).

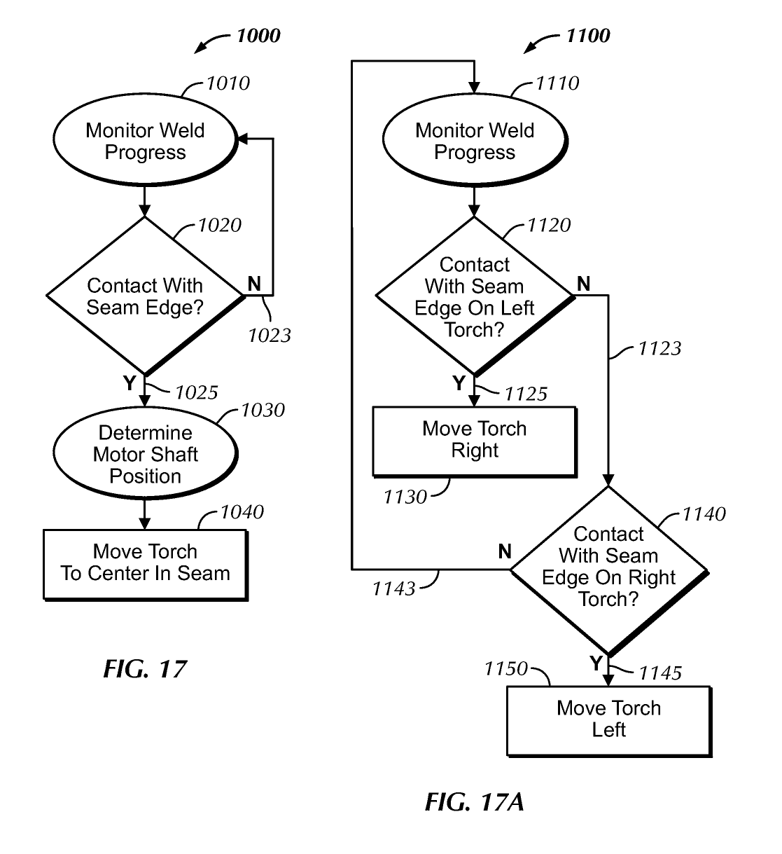

The extended wand/tip/wire combination, referred to hereafter as “the wand,” rotates around a center line of the torch (CTR). If the wand contacts the metal's left plate (M_{L}), and the controller determines the wand is on the left side position (410), then the carriage (C) moves to the right (420) to re-center the torch (T). If the wand contacts the metal's right plate (M_{R}), and the controller determines the wand is on the right side position (410′), then the carriage (C) moves to the left (430) to re-center the torch (T). See FIG. 17.

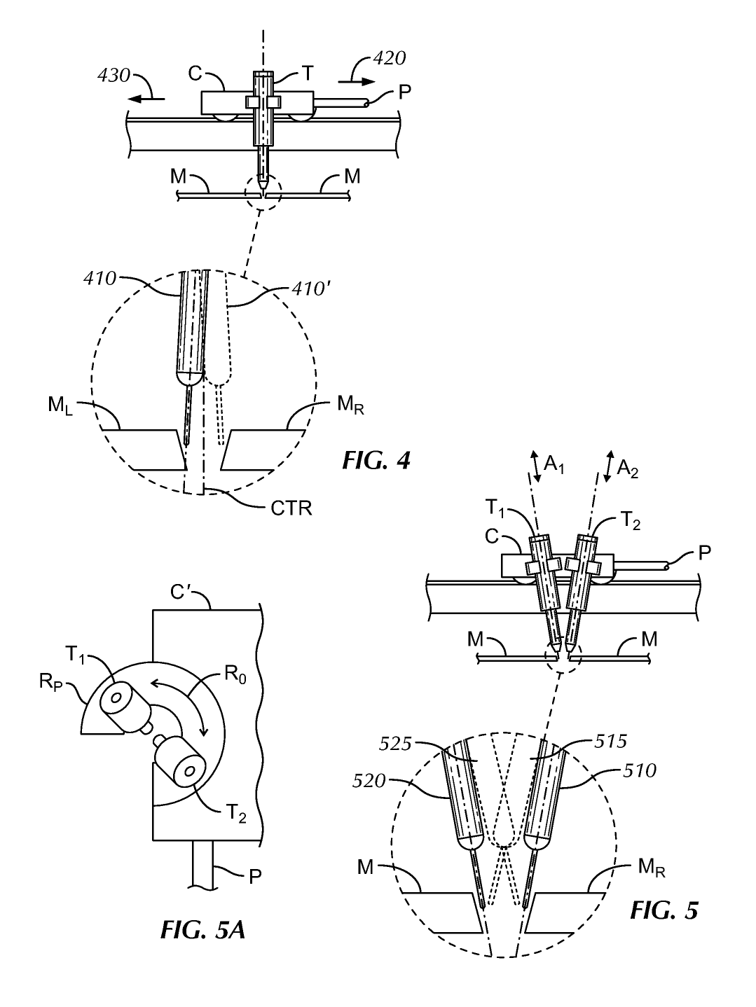

FIG. 5 is a diagrammatic elevational view of a mechanized continuous arc welding apparatus incorporating a plurality of improved torches in accordance with an exemplary embodiment of the invention. The carriage (C) is mounted upon a track (N) and moved along the track (N) by the plunger (P). Metal plates (M) which are to be welded together are positioned alongside the track (N) and below the torches (T1 and T2). While the track (N) is shown as a straight section, one skilled in the art would appreciate that the track may have other shapes and orientations and is simply to provide a stable conveyance path on which the carriage (C) is to travel.

The extended wand/tip/wire combinations, referred to hereafter as the wands, rotate around the center line of the torches. If the wand of (T1) contacts the left metal plate (M) and the controller determines the wand is on the left side position (520), then the carriage (C) moves to the right to re-center the torches (T1 and T2). If the wand of (T2) contacts the right metal plate (M) and the control determines the wand is on the right side position (510), then the carriage (C) moves to the left to re-center the torches (T1 and T2). If the wand of (T1) contacts the right metal plate (M) and the controller determines the wand is on the right side position (525), then the torch (T1) is angled closer to the other torch (T2) or the radius of the rotation is decreased. If the wand of (T2) contacts the left metal plate (M) and the controller determines the wand is on the left side position (515), then the torch (T2) is angled closer to the other torch (T1) or the radius of the rotation is decreased. See FIG. 17A.

The wands of the Torches (T1 and T2) may be adjustable in length, as described later to compensate for changes in the seam path in relation to the track (N). Further, the adjustment may be utilized to allow for continuous paths in welding thick metal (M). Additionally, the torches (T1 and T2) may be adjustable in their relation to the carriage (C) along their center axis as indicated by the movement indicators (A1 and A2). Such adjustments (A1 and A2) may be in place of, or in addition to the adjustable lengths of the wands as discussed below.

FIG. 5A is another diagrammatic elevational view of a mechanized continuous arc welding apparatus incorporating a plurality of improved torches, and a rotational offset capability in accordance with an exemplary embodiment of the invention. The carriage (C′) with rotational offset capability, contains a rotational platform (RP) to which the torches (T1 and T2) are mounted. A plunger (P) moves the carriage (C′) along the tracks (not shown) along the weld seam. Rotation of the rotational platform (RP) determines the rotational offset (RO) of the torches. The two torches (T1 and T2) may be positioned parallel to the seam or perpendicular to the seam, or anywhere in between.

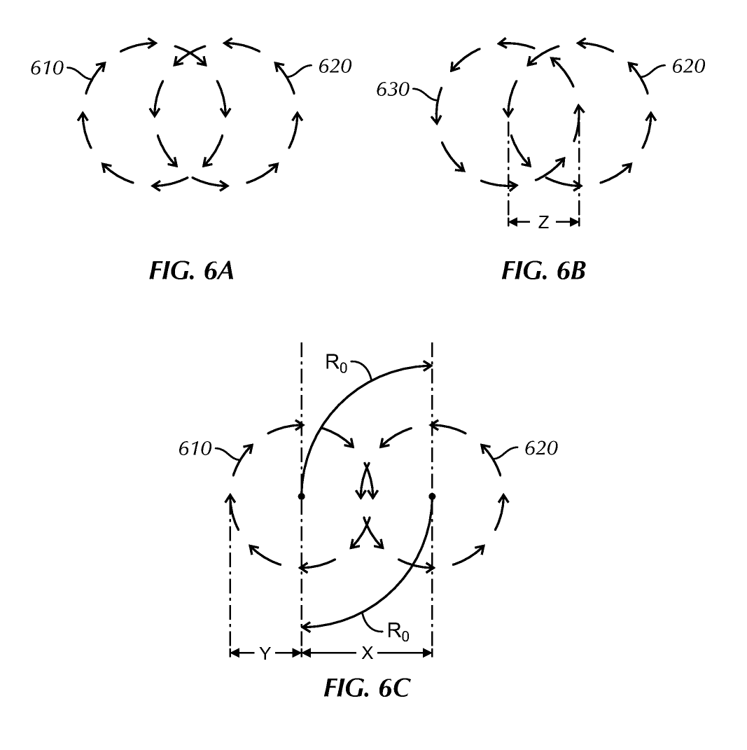

FIGS. 6A, 6B, and 6C are diagrams of exemplary welding paths and characteristics thereof for multi torch systems as illustrated in FIG. 5. The multi torch system, due to the precise control achievable with stepping motors, may operate a plurality of torches in close proximity. FIG. 6A illustrates an exemplary path of two torches. The first path (610) is a clockwise rotation while the second path (620) is a counter clockwise rotation. In one embodiment two wands may be located in the same torch body, and may be located within a single gas shield.

In another embodiment, illustrated by FIG. 6B, a first path (630) is counter clockwise, while the second path (620) remains counter clockwise. The two paths overlap by an amount (Z), adjusted by adjusting the angle of the torches, or the amount of overlap may be adjusted by setting the radius of the paths (610-630).

FIG. 6C illustrates how the torch paths may be positioned differently to adjust the distance between the two centers (X) or to increase or decrease the radius (Y). In actual practice, the distance between the two centers (X) and twice the radius (Y) must be less than the width of the slot, or the orientation must be angled with respect to the slot to avoid grounding the electrode wires (W, not shown) against the metal (M, not shown).

The torch paths (610 and 620) define a linear angle which may be rotated to a specific rotational offset (RO) as described above, to determine their alignment in relation to the weld seam. While limited rotation in a clockwise direction is indicated by the figure, one skilled in the art would appreciate that rotation may be in multiple directions, and potentially in different planes to position the torches in unique positions for unique welding situations.

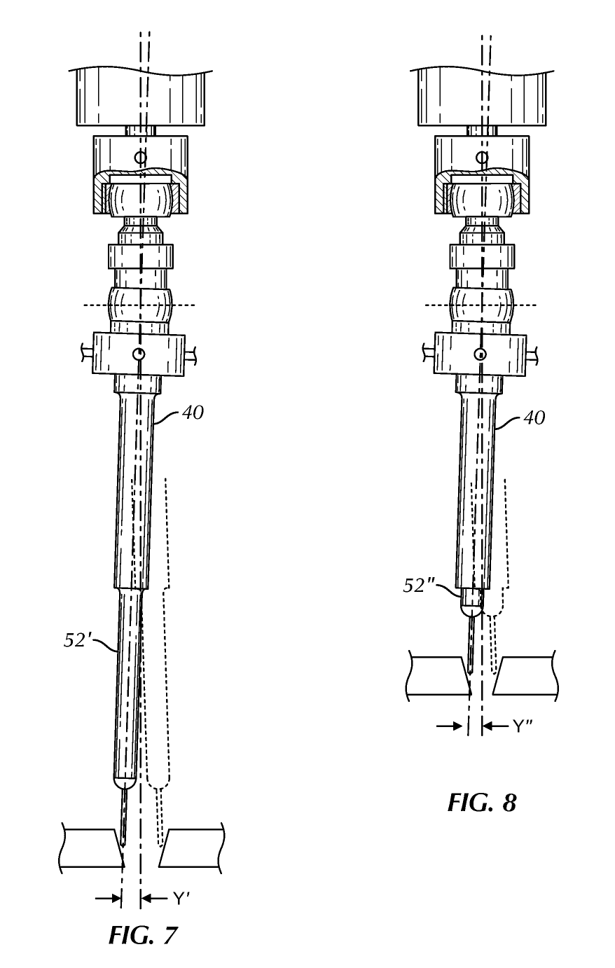

FIGS. 7 and 8 are elevational views of certain operative components within the torch and showing in a somewhat exaggerated manner the movement of a wand carrying the electrode wire and the effect of adjustments and alternatives thereon in accordance with exemplary embodiments of the invention. The length of the elongated end of the wand (40) and the tip (52′ and 52″) affect the radius of the path (Y′ and Y″). A longer tip (52′) results in a larger radius (Y′) for a given angular displacement from the center line. A shorter tip (52″) results in a smaller radius (Y″) for the same given angular displacement from the center line.

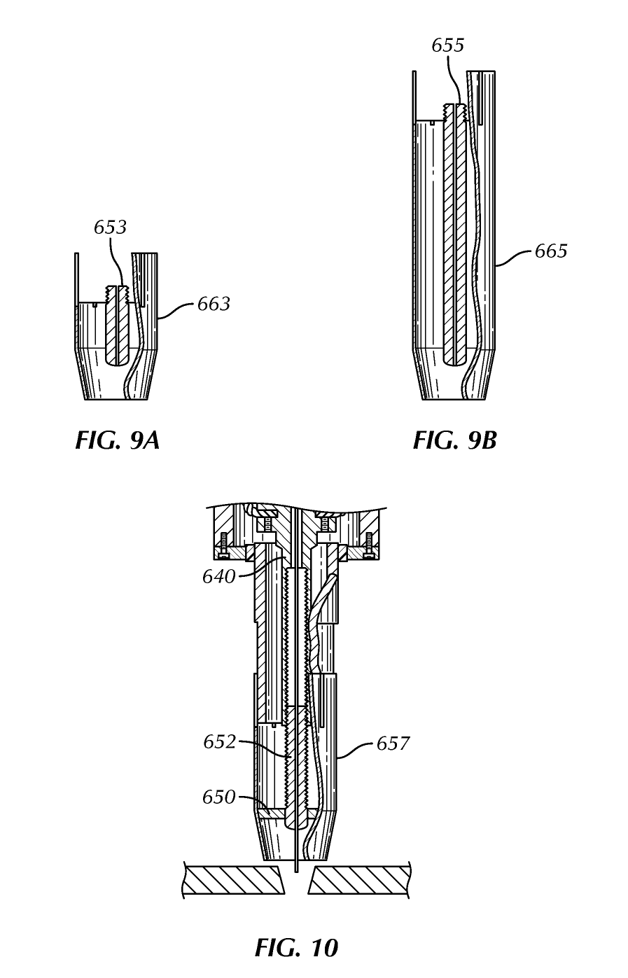

FIGS. 9A, 9B, and 10 show sectional elevations of certain operative components within the torch in accordance with an exemplary embodiment of the invention. One way to achieve the shorter tip is illustrated in FIG. 9A by using a physically shorter tip (653) and a corresponding shortened gas shield (663). One way to achieve the longer tip is illustrated in FIG. 9B by using a physically longer tip (655) and a corresponding lengthened gas shield (665).

An alternative way to accomplish the adjustment to the wand length, is to bore and thread the inside of the elongated end of the wand (640), and thread the outer edge of the tip (652). The tip can now be screwed in and out of the elongated end of the wand to adjust the length of the wand. If the wand is configured to spin the wand's elongated end, while preventing the spinning of the tip, the adjustment can be made in real time during welding operations to account for welding of non-planer materials while maintaining the torch body at a fixed height.

An insulating retainer ring (650) may be utilized to keep the end of the tip (652) and the gas shield (657) in similar positions in relation to each other. By use of the retainer ring (650), the gas shield (657) is moved up and down along with the tip (652). Additionally, in one embodiment, the gas shield (657) through the retainer right (650) may be utilized as the means of preventing the rotation of the tip (652) when the elongated wand (640) is rotated to make the adjustment.

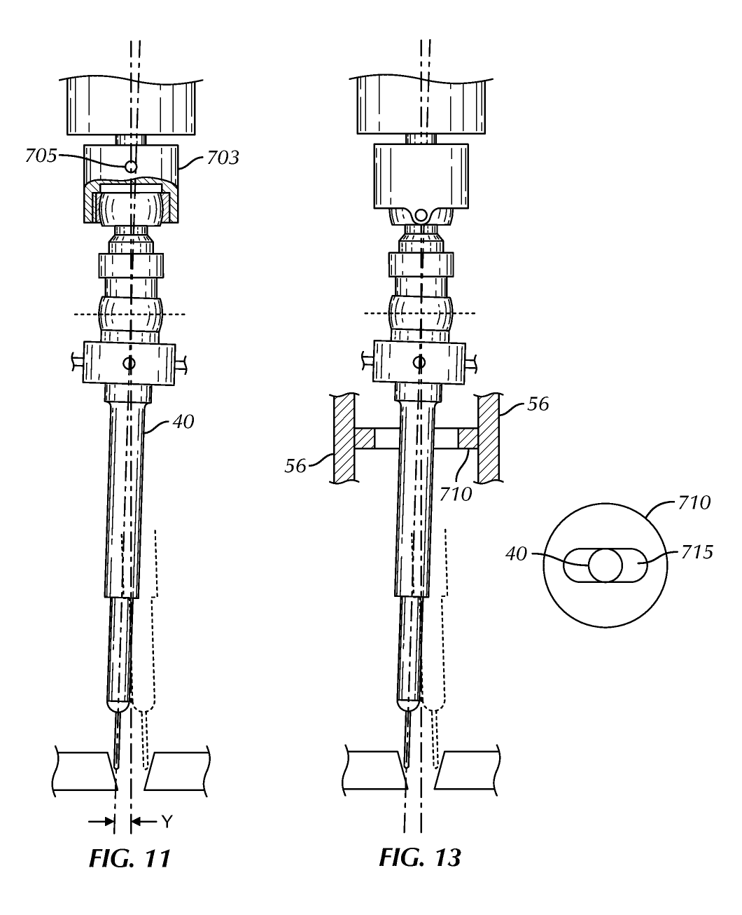

FIG. 11 shows exemplary configuration of components within the torch which are free to rotate and swing in any direction, being controlled by the stepping motor. The adjustable eccentric coupling (703) comprises an adjustment point (705) which allows the eccentric nature of the coupling's relation to the motor shaft (not designated) to be adjusted. Adjustments to the eccentric relation between the motor shaft and the bearing's outer ring directly relate to the movement experienced at the tip of the wand and illustrated in the drawing as the diameter of the swing (Y).

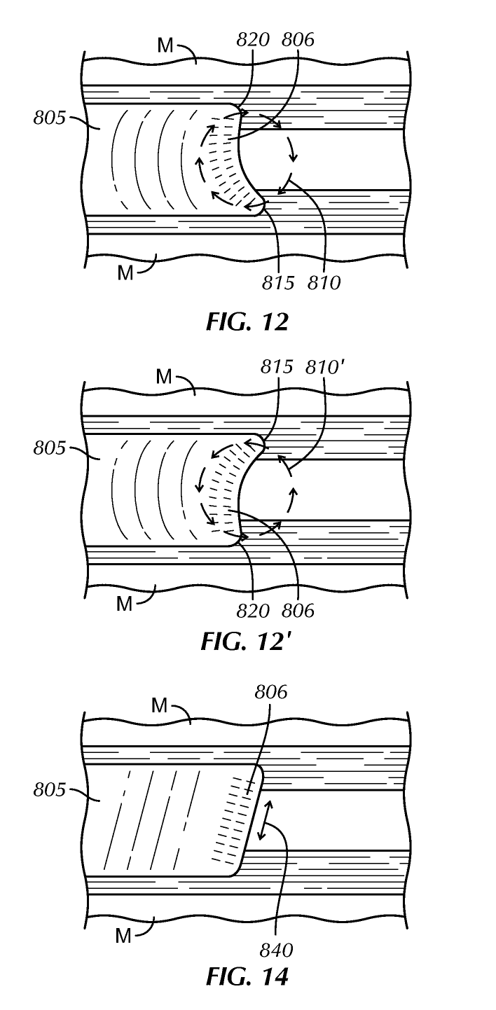

FIGS. 12 and 12′ illustrate the character of welds possible with the improved torch. The metal plates (M) are joined by the weld puddle (805) which has a leading edge (806) which is crescent shaped. The paths (810 and 810′) show that the attacking end results in a leading edge to the puddle (815) while the retreating end results in a trailing edge (820). This can be eliminated by reversing the direction of the rotation periodically to keep both edges (815 and 820) of the puddle progressing evenly. Alternatively, the process can be used to adjust the extent to which the leading edge (815) advances before the trailing edge (820), which can be compensative of differences in the joined metals (M).

FIG. 13 shows the use of a guiding washer (710) which limits wand (40) movement within the barrel of the torch by providing a shaped opening (715), here illustrated as an elliptical opening is positioned between the wand and the gas shield tube (56), which limits wand rotation to a singular plane of motion resulting in a back and forth path movement (840, FIG. 14). In the preferred embodiment, the controller adjusts step speed, direction, motor torque, and wand length, to accomplish the same control over tip rotation without the need to disassemble and change guiding washers (7-15). This preferred embodiment also allows for changes in technique in real time during a single weld seam.

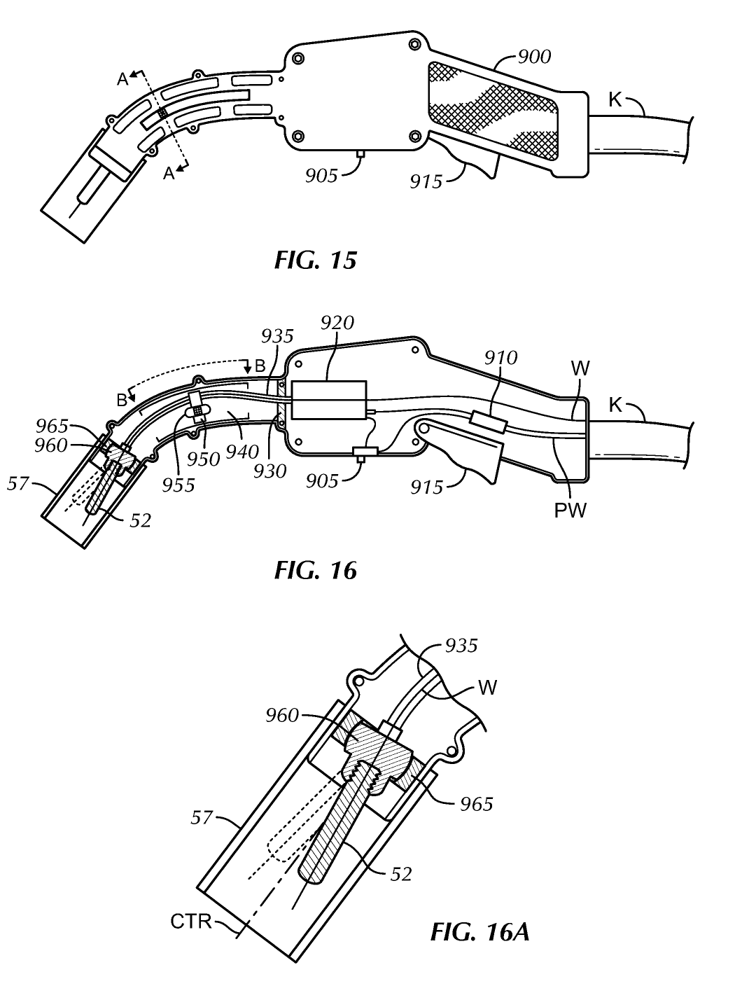

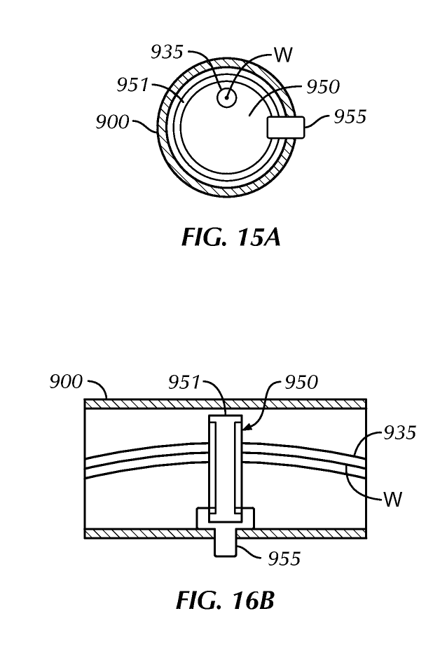

FIG. 15 illustrates an elevational view of an alternative embodiment of a torch in accordance with an exemplary embodiment of the invention. This embodiment utilizes a less costly and less robust simpler design for a rotating electrode torch which is ideal for a consumer market. The torch body's (900) base end has a standard flexible multipurpose, tubular carrier conduct (K) found on most units. A trigger control (915) and other controls (905) adjust the speed and direction of the electrode rotation.

FIG. 15A shows a transverse sectional view as taken from the indicated line A-A at FIG. 15. The body (900) contains the eccentric washer (950) which spins within. The slider (955) snaps to the lip (951) and the opening for the flexible cable (935) rotates around the center as the cable rotates along with the wire (W).

FIG. 16 shows a cross sectional elevation of the alternative embodiment of the torch illustrated in 15. The wire (W) enters the body (900) at the base end through the flexible multipurpose, tubular carrier conduct (K) along with the power (PW) and optional shielding gas (GS not indicated). The speed control (910) adjusted by the trigger (915) control the feed rate of the wire, and the rotation rate of the wire, which may be proportionally linked in a factory preset or user adjustable ratio. Alternative embodiment may have separate controls for the two settings, and still alternate embodiments may limit the hand held controls to one or the other, with remaining controls located elsewhere on accompanying equipment.

Controls (905) may be used to determine direction of rotation, speed of rotation, or even to stop rotation. The motor (920) couples with a flexible cable (935) through which the wire (W) passes to reach and pass through a rocker bearing (960) and its corresponding retainer sleeve (965) located near the base end of the body. The rocker bearing also has an elongated end for connecting the tip (52). An eccentric washer (950) causes the flexible cable (935) to be diverted from a central position and thus imparts a rotation to the rocker bearing (960/965) as the motor (920) rotates the wire (W). This results in the tip (52) tracing a conic trajectory within the gas shield (57). Sliding the eccentric washer (950) along the adjuster path (940) with a slider (955), which protrudes out the side of the body (900), relationally increases, or decreases the exaggeration of the conic trajectory.

FIG. 16A shows an enlarged view of the base end of the torch body illustrated in FIG. 16. FIG. 16A shows how the movement of the flexible cable (935) on one side of the rocker bearing (960) causes a movement within the retainer right (965) which moves the tip (52) around the center (CTR) of the gas shield (57).

FIG. 16B shows a transverse sectional view as taken from the indicated line B-B at FIG. 16. The body (900) contains the eccentric washer (950) which spins within. The slider (955) grips the lip (951) to allow movement along the adjuster path (940). The opening for the flexible cable (935) diverts the cable and encompassed wire (W) from the center of the body (900).

FIG. 17 diagrams a method of use for a mechanized continuous arc welding apparatus incorporating the improved torch as illustrated in FIG. 4. The chart (1000) illustrates the process for operating the mechanized welding apparatus previously discussed. The weld progress is continuously monitored (1010). Monitoring the weld progress may involve a combination of one or more of the following: monitoring motor feedback resistance to movement; monitoring the sound of the weld for changes in the “sputtering” or “buzz” to determine deviations in the sound patterns. Additionally, arc shorting, or current draw of the weld tip may indicate changes in the weld's progression. If contact with a seam edge (1020) is not detected (1023), monitoring continues. If contact with a seam edge (1020) is detected (1025), determining the position of the motor shaft (1030) determines how the carriage should be moved (1040) to center the torch in the seam.

FIG. 17A diagrams a method of use for a mechanized continuous arc welding apparatus incorporating a plurality of improved torches as illustrated in FIG. 5. The chart (1100) illustrates the process for operating the mechanized welding apparatus previously discussed. The weld progress is continuously monitored (1110) as previously discussed. If contact with a seam edge (1120) of the left torch is not detected (1123) the system determines if seam edge contact is made with the right torch (1140) and if not detected (1143) monitoring continues.

If contact with the seam edge (1120) is detected on the left torch (1125), since we know the left torch is always on the left side of the weld, we know the carriage must be moved right (1130) to center the torch in the seam. If contact with the seam edge (1140) is detected on the right torch (1145), since we know the right torch is always on the right side of the weld, we know the carriage must be moved left (1150) to center the torch in the seam.

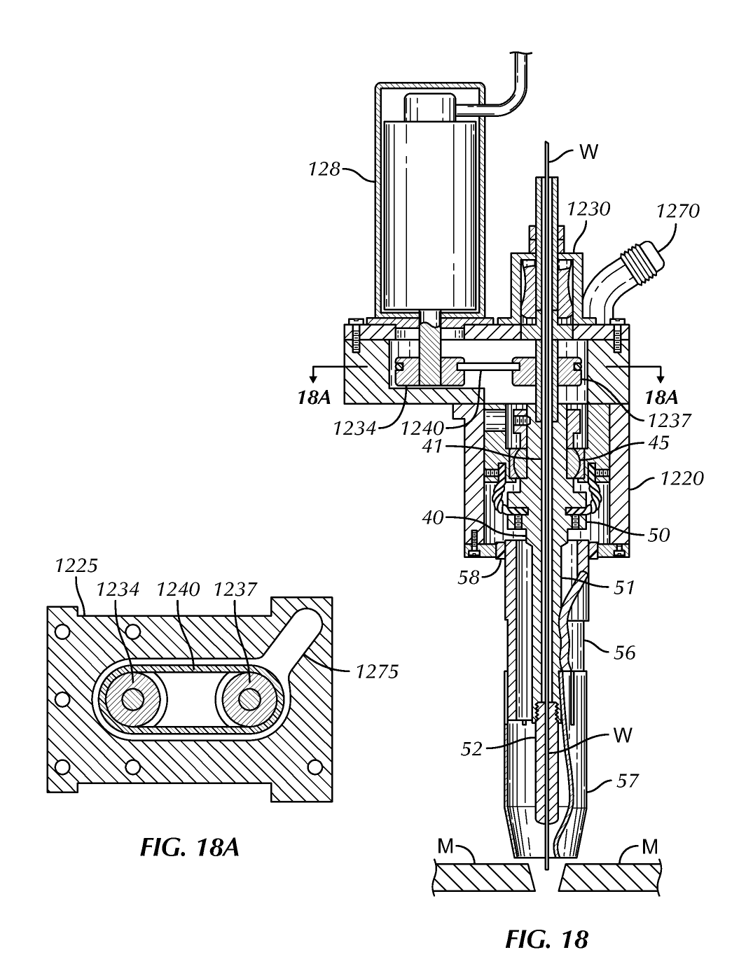

FIG. 18 is a diagrammatic elevational view of a continuous arc welding torch in accordance with an exemplary embodiment of the invention. FIG. 18A shows a transverse sectional view as taken from the indicated line 18A-18A at FIG. 18. This embodiment of a torch is configured for use on mechanized carriages or robotic arms for automated welding operations. The primary differences between this embodiment and previous embodiments described herein is the use of an offset motor with electrical isolation to prevent welding voltages and arcing from interfering with electronics on stepping motors and any attached controllers and/or computers.

The electrode wire (W) extends into the upper wire guidance (1230) which guides the wire (W) through an axial passageway (41) to the tip (52) of the wand (40). The rocker bearing (45) allows free movement of the wand (40) as described in previous embodiment. The movement of the wand (40) translates into movement of the elongated extension (51) and the tip (52) creating a shaped conical movement of the wire (W) within the shielding cap (57) extending from the gas shield tube (56) and insulated from the body by an insulating ring (58) in the lower body (1220).

The lower body (1220) connects to an upper body (1225) onto which mounts the stepping motor (128) in optional housing. A gas supply connector port (1270) leads to a gas chamber (1275) in the upper body (1225) which is open to the lower body (1220) to allow shielding gas to reach the shielding gas tube (56) where it flows to the metal (M) and surrounds the weld. The stepping motor (128) has a rotor head pulley (1234) which is connected to a wand pulley (1237) either, or both of which may be eccentric in shape. The connection is accomplished by an electrically insulating belt (1240).

I have now described my invention in considerable detail. It is obvious, however, that others can build and devise alternate and equivalent constructions and operations which are within the spirit and scope of my invention. Hence, I desire that my protection be limited, not by the constructions and operations illustrated, and described, but only by the proper scope of the appended claims.

The flow diagrams in accordance with exemplary embodiments of the present invention are provided as examples and should not be construed to limit other embodiments within the scope of the invention. For instance, the blocks should not be construed as steps that must proceed in a particular order. Additional blocks/steps may be added, some blocks/steps removed, or the order of the blocks/steps altered and still be within the scope of the invention. Further, blocks within different figures can be added to or exchanged with other blocks in other figures. Further yet, specific numerical data values (such as specific quantities, numbers, categories, etc.) or other specific information should be interpreted as illustrative for discussing exemplary embodiments. Such specific information is not provided to limit the invention.

The diagrams in accordance with exemplary embodiments of the present invention are provided as examples and should not be construed to limit other embodiments within the scope of the invention. For instance, heights, widths, and thicknesses may not be to scale and should not be construed to limit the invention to the particular proportions illustrated. Additionally, some elements illustrated in the singularity may actually be implemented in a plurality. Further, some element illustrated in the plurality could actually vary in count. Further, some elements illustrated in one form could actually vary in detail. Further yet, specific numerical data values (such as specific quantities, numbers, categories, etc.) or other specific information should be interpreted as illustrative for discussing exemplary embodiments. Such specific information is not provided to limit the invention.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. In a torch for continuous arc welding which includes a body through which an electrode wire moves, into the head end of the body and from the base end thereof, and means to produce a wire consuming electric arc as the wire moves from the base end of the body, an elongated wand within the body having a head end within the body and a base end at the base end of the body, an axial passageway from the head end to the base end through which the electrode wire moves, and a tip at the base end with the arcing end of the wire being extended therefrom; and a rotation means adapted to move the wand and the arcing end of the wire in a circular path and including a motor within the body adjacent to the head end of the body and having a tubular shaft in substantial alignment with the wand, with the electrode wire being extended through the motor shaft and into the wand passageway, a rotor head having an eccentric mount means is mounted on the motor shaft and the head end of the wand is carried in the eccentric mount means to move in a circular path as the motor shaft rotates the rotor head, and the diameters of the passageways through the motor shaft and wand, with respect to the eccentricity of the mount means, are sufficient to permit movement of the electrode wire from the motor shaft and into the wand, the improvement comprising:
the motor being a stepping motor configured to provide precise positioning and control;
a controller configured to receive an input control signal and to responsively move the shaft of the motor clockwise or counter clockwise in a step wise manner.

2. The torch defined in claim 1 wherein the controller is further configured to provide an output signal reporting a relative position of the motor's shaft with respect to a known position.

3. The torch defined in claim 1 wherein the controller is further configured to provide an output signal reporting a feedback resistance to the motor's movement.

4. The torch defined in claim 1 further comprising:
a handle attached to the body;
the handle comprising a plurality of controls,
the controls configured to provide input to the controller.

5. The torch defined in claim 4 wherein the controls determine at least one of the following:
direction of rotation;
speed of rotation;
maximum feedback resistance to the motor's movement; and/or
the feed rate of the wire.

6. The torch defined in claim 1 wherein:
the tip further comprises varying lengths; and
the elongated wand's base end having a threaded inner surface of the axial passageway; and
the tip having a threaded external surface extending at least twenty percent of the tip's length;
the threaded external surface of the tip mating with the threaded inner surface of the axial passageway thus allowing the tip being adjustably inserted into the wand's base end and thus adjusting the length of the combination elongated wand and tip.

7. The torch defined in claim 6 wherein:
the elongated wand's base end adapted for rotation under control of the controller;
the tip end adapted to prevent rotation such that rotation of the wand's base end adjusts the length of the combination elongated wand and tip.

8. The torch defined in claim 7 wherein:
the length of the combination elongated wand and tip are adjusted responsively to input during weld operations.

9. The torch defined in claim 1 wherein the torch further comprises input for gases on the torch body near the torch tip and prevents said gas from reaching the motor.

10. The torch defined in claim 1 wherein the controller is configured to control the speed and/or the direction of the motor.

11. The torch defined in claim 1 wherein the wand's lateral movement is restricted to move in substantially a single plane.

12. The torch defined in claim 1 further comprising:
a carriage supporting the body of the torch configured to be movable in a plane substantially perpendicular to the plane of a weld seam.

13. The torch defined in claim 12 wherein the controller is configured to:
determine resistance in the tip of the torch;
determine the position of the motor;
position the carriage to reduce resistance in the tip of the torch.

14. The torch defined in claim 13 wherein the controller is further configured to:
determine repeated repositioning of the carriage;
and adjust the distance of the movement of the tip of the torch to reduce movement of the carriage.

15. The torch defined in claim 12 further comprising:
a second torch supported by the carriage; and
a master controller configured to:
control the position of the carriage relative to the weld seam,
control the relative position of the torches to each other, and
communicate with the controllers in each of the two torches.

16. The torch defined in claim 15 wherein the first torch and the second torch operate on a single weld puddle.

17. In a torch for continuous arc welding which comprises:
a body through which an electrode wire moves, from the head end of the body and toward a base end thereof,
a means to produce a wire consuming electric arc as the wire moves from the base end of the body,
a flexible cable shield within the body having a head end within the body and a base end at the base end of the body,
an axial passageway from the head end to the base end through which the electrode wire moves;
a motor configured to rotate the head end of the flexible cable;
a tip at the base end of the body;
with the arcing end of the wire being extended therefrom;
a rocker bearing between the tip and the flexible cable,
the tip being removably attached thereto,
the distal side of the rocker bearing being affixed to the flexible cable, and
the electrode wire passing there through.

18. The torch defined in claim 16 further comprising:
a rotating spacer configured to deflect the flexible cable from the center of the body, thus producing and circular path of the wire electrode passing through the base of the tip.

19. The torch defined in claim 18 wherein the rotating spacer is slidedly movable within the body of the torch, along the flexible cable, thus adjusting the circular path of the wire electrode.

20. The torch defined in claim 16 further comprising:
a controller having inputs and outputs,
the controller being configured to adjust at least one of the following:
the direction of rotation of the flexible cable;
the speed of rotation of the flexible cable; and/or
the force of rotation of the flexible cable:
